(19) United States
(12) Patent Application Publication
(10) Pub. No.: US 2017/0041897 A1
(43) Pub. Date: Feb. 9, 2017

(54) APPARATUS AND METHODS FOR SYNCHRONIZING A CONTROLLER AND SENSORS

(71) Applicant: QUALCOMM Incorporated, San Diego, CA (US)

(72) Inventors: Radu Pitigoi-Aron, San Jose, CA (US); Leonid Sheynblat, Hillsborough, CA (US); Carlos Puig, Santa Clara, CA (US); Justin Black, Santa Clara, CA (US); Rashmi Kulkarni, Menlo Park, CA (US)

(21) Appl. No.: 15/299,382

(22) Filed: Oct. 20, 2016

Related U.S. Application Data
(63) Continuation-in-part of application No. 15/251,757, filed on Aug. 30, 2016.
Application No. 15/251,757 is a continuation of application No. 14/304,699, filed on Jun. 13, 2014, now Pat. No. 9,436,214.
(60) Provisional application No. 61/903,243, filed on Nov. 12, 2013.
(60) Provisional application No. 62/245,914, filed on Oct. 23, 2015.
(60) Provisional application No. 62/245,917, filed on Oct. 23, 2015.
(60) Provisional application No. 62/245,922, filed on Oct. 23, 2015.
(60) Provisional application No. 62/245,924, filed on Oct. 23, 2015.

(51) Int. Cl. H04W 56/00

(52) U.S. Cl. CPC H04W 56/0045; H04W 56/0015; H04W 84/18

(57) ABSTRACT

Disclosed are methods and apparatus for transmitting sensor timing correction messages with a host controller. The methods and apparatus determine synchronization messages that are transmitted to a sensor coupled with the host controller via an interface, where the messages indicate a beginning of a synchronization period for synchronizing timing of the host controller and the sensor. Additionally, a delay time message is determined that indicates a time delay between the beginning of the synchronization period and an actual transmission time of the synchronization message. The synchronization message is transmitted with the delay time message in an information message to the sensor, where information message is configured to allow the sensor to correct timing of a sensor timer by accounting for the delay time.

### CLAIM OF PRIORITY UNDER 35 U.S.C. §120

The present application for patent is a Continuation in Part of U.S. patent application Ser. No. 15/251,757 entitled “SYSTEM AND METHODS OF REDUCING ENERGY CONSUMPTION BY SYNCHRONIZING SENSORS” filed Aug. 30, 2016, pending, and assigned to the assignee hereof and hereby expressly incorporated by reference herein, which claimed priority to U.S. patent application Ser. No. 14/304,699, now U.S. Pat. No. 9,436,214, which in turn claimed the benefit of priority of U.S. provisional patent application No. 61/903,243 filed on Nov. 12, 2013.

### CLAIM OF BENEFIT UNDER 35 U.S.C. §119

The present application for patent claims the benefit of U.S. Provisional Application No. 62/245,914 entitled “CORRECTION OF SYNC TICK IN A SYSTEM SYNCHRONIZING CONTROLLER AND SENSORS” filed Oct. 23, 2015, U.S. Provisional Application No. 62/245,917 entitled “ACHIEVING ACCEPTABLE CONTROL FOR THE RANGE OF SENSOR CLOCK TIMING IN A SYSTEM SYNCHRONIZING CONTROLLER AND SENSORS” filed Oct. 23, 2015, U.S. Provisional Application No. 62/245,922 entitled “REDUCTION OF TIME STAMP OVERHEAD IN A SYSTEM SYNCHRONIZING CONTROLLER AND SENSORS” filed Oct. 23, 2015, and U.S. Provisional Application No. 62/245,924 entitled “TIMESTAMP FOR ASYNCHRONOUS EVENT” filed Oct. 23, 2015, all of which are assigned to the assignee hereof and hereby expressly incorporated by reference herein.

### BACKGROUND

Field

The subject matter disclosed herein relates to electronic devices, and more particularly to methods, apparatus, and systems for synchronizing controllers and sensors.

Background

Modern-day mobile devices contain many sensors. Usually, a data processing unit, controller, host device, or master device (hereinafter referred to as simply a controller or a host controller) is provided to receive and process data collected by sensors or slave units (hereinafter referred to a “sensor”). To conserve power, the controller is regularly placed into a sleep state when no data is being transferred from the sensors to the controller.

Two methods of transferring data from sensors to a controller are commonly utilized. In the first method, which is known as the asynchronous method, a sensor with available data to transfer notifies the controller by issuing a signal (e.g., a Data Ready Interrupt (DRI) signal through a dedicated DRI pin for certain known systems), which wakes up the controller, and then the sensor transfers the data when the controller is ready. In the second method, which is known as the synchronous method, the controller wakes up from the sleep state spontaneously at predetermined time intervals, polls the sensors, and receives from the sensors whatever data is present at the sensors. The synchronous method is more energy efficient in a device comprising multiple sensors because data transfers from more than one sensor may be consolidated into a single poll and transfer session.

In systems where multiple sensors or other devices provide periodically sampled data, it is further advantageous to be able to instruct the sensors to collect the data at essentially synchronized times, and for the controller to read the data from several sensors within the same awake time window or system awake period. Ideally, assuming a sensor delivers only the most current results, polling a sensor at a frequency that coincides with the sensor's sampling frequency is sufficient to obtain all the data collected by the sensor. However, because the controller and the sensors do not usually share timing signals and misalignment of the timing signals may therefore result, some sensor data samples may be lost and some sensor data samples may be read twice even when the sensors are polled at their sampling frequencies. The phenomenon is exacerbated by the fact that some sensors have poor clock or timer accuracy (e.g., ±15% deviation over a temperature range and from device to device).

### SUMMARY

According to an aspect, a method for transmitting sensor timing correction messages implemented with a host controller is disclosed. The method includes determining a synchronization message, the synchronization message configured to be transmitted to a sensor and to indicate a beginning of a synchronization period for synchronizing timing of the host controller and the sensor. A delay time message is also determined where the delay time message is configured to indicate a time delay between the beginning of the synchronization period and an actual transmission time of the synchronization message. The method further includes transmitting the synchronization message with the delay time message in an information message to the sensor, wherein the information message is configured to allow the sensor to correct timing of a sensor timer.

In another aspect, a host controller device is disclosed having a transport medium interface configured to communicatively coupled to at least one sensor device via at least one transport medium. The host controller further includes at least one processing circuit communicatively coupled to the transport medium interface and configured to determine a synchronization message, the synchronization message configured to be transmitted to a sensor and to indicate a beginning of a synchronization period for synchronizing timing of the host controller and the sensor. The at least one processing circuit is further configured to determine a delay time message configured to indicate a time delay between the beginning of the synchronization period and an actual transmission time of the synchronization message, and transmit the synchronization message with the delay time message in an information message to the sensor, wherein the information message is configured to allow the sensor to correct timing of a sensor timer.

According to yet a further aspect, a processor-readable storage medium is disclosed, where the medium has one or more instructions which, when executed by at least one processing circuit, cause the at least one processing circuit to determine a synchronization message, the synchronization message configured to be transmitted from a host controller to a sensor on a transport medium and to indicate a beginning of a synchronization period for synchronizing timing of the host controller and the sensor. The instructions further cause the at least one processing circuit to determine a delay time message configured to indicate a time delay between the beginning of the synchronization period and an actual transmission time of the synchronization message, and transmit the synchronization message with the delay time message in an information message to the sensor, wherein the information message is configured to allow the sensor to correct timing of a sensor timer.

### BRIEF DESCRIPTION OF THE DRAWINGS

FIG. 1 is block diagram illustrating an exemplary mobile device in which the presently disclosed methods and apparatus may be implemented.

FIG. 2 is block diagram illustrating an exemplary hardware environment in which the presently disclosed methods and apparatus may be implemented.

FIG. 3 is a flowchart illustrating an exemplary method for synchronizing a host controller and sensor timers.

FIG. 4 illustrates an exemplary system timing diagram of activity on an interface.

FIG. 5 illustrates a timeline diagram showing an example of a synchronization procedure on an interface.

FIG. 6 illustrates a timeline diagram showing setting of polling timing by accounting for jitter and synchronization messaging timing.

FIG. 7 illustrates a flowchart of an exemplary method for transmitting sensor timing correction messages.

FIG. 8 illustrates a flowchart illustrating an exemplary method 800 for determining the read time window as illustrated in FIG. 6.

FIG. 9 illustrates an exemplary host controller or master device according to the present disclosure.

FIG. 10 illustrates an exemplary slave or sensor device according to the present disclosure.

FIG. 11 is a diagram illustrating a simplified example of a hardware implementation for a host controller.

### DETAILED DESCRIPTION

Aspects of the disclosed methods and apparatus are disclosed in the following description and related drawings directed to specific embodiments. Alternate embodiments may be devised without departing from the scope of the present disclosure. Additionally, well known elements may not be described in detail or may be omitted so as not to obscure the relevant details of the disclosure.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”. “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

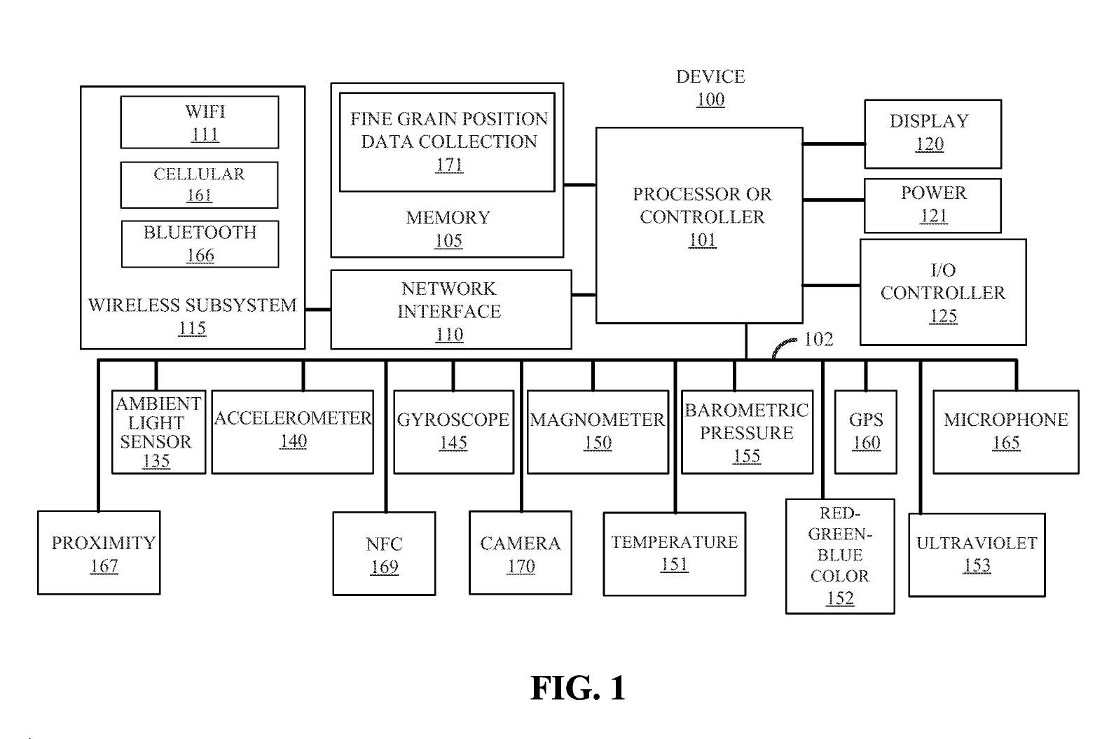

FIG. 1 is block diagram illustrating an exemplary mobile device in which embodiments of the presently disclosure may be practiced. The system may be a device (e.g., device 100), which may include one or more processors 101, a memory 105, I/O controller 125, and network interface 110. Device 100 may also include a number of device sensors coupled to one or more buses or signal lines further coupled to the processor 101. It should be appreciated that device 100 may also include a display 120, a user interface (e.g., keyboard, touch-screen, or similar devices), a power device 121 (e.g., a battery), as well as other components typically associated with electronic devices. In some embodiments, device 100 may be a mobile or non-mobile device. Herein “processor” and “data processing unit” are used interchangeably.

The device (e.g., device 100) can include sensors such as ambient light sensor (ALS) 135, accelerometer 140, gyroscope 145, magnetometer 150, temperature sensor 151, barometric pressure sensor 155, red-green-blue (RGB) color sensor 152, ultra-violet (UV) sensor 153, UV-A sensor, UV-B sensor, compass, proximity sensor 167, near field communication (NFC) 169, and/or Global Positioning Sensor (GPS) 160. In some embodiments, multiple cameras are integrated or accessible to a device. For example, a mobile device may have at least a front and rear mounted camera. In some embodiments, other sensors may also have multiple installations or versions.

Memory 105 may be coupled to processor 101 to store instructions for execution by processor 101. In some embodiments, memory 105 is non-transitory. Memory 105 may also store one or more models or modules to implement embodiments described below. Memory 105 may also store data from integrated or external sensors.

Network interface 110 may also be coupled to a number of wireless subsystems 115 (e.g., Bluetooth 166, WiFi 111, Cellular 161, or other networks) to transmit and receive data streams through a wireless link to/from a wireless network, or may be a wired interface for direct connection to networks (e.g., the Internet, Ethernet, or other wired or wireless systems). The mobile device may include one or more local area network transceivers connected to one or more antennas (not shown). The local area network transceiver comprises suitable devices, hardware, and/or software for communicating with and/or detecting signals to/from wireless APs, and/or directly with other wireless devices within a network. In one aspect, the local area network transceiver may comprise a WiFi (802.11x) communication system suitable for communicating with one or more wireless access points.

The device 100 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, LTE Advanced, WCDMA, UMTS, 4G, 5G, or GSM. Additionally, any other type of wireless networking technologies may be used, for example, WiMax (802.16), Ultra Wide Band, ZigBee, wireless USB, etc.

Additionally device 100 may be a mobile device, a wireless device, a cell phone, a personal digital assistant, a mobile computer, a wearable device (e.g., head mounted display, virtual reality glasses, etc.), a robot navigation system, a tablet, a personal computer, a laptop computer, or any type of device that has processing and/or communication capabilities. As used herein, a mobile device may be any portable, or movable device or machine that is configurable to acquire wireless signals transmitted from, and transmit wireless signals to, one or more wireless communication devices or networks. Thus, by way of example, but not limitation, the device 100 may include a radio device, a cellular telephone device, a computing device, a personal communication system device, or other like movable wireless communication equipped device, appliance, or machine. Any operable combination of the above are also considered a “mobile device.”

Furthermore, the mobile device 100 may communicate wirelessly with a plurality of wireless access points (APs), NodeBs, eNodeB's, base stations, etc. using RF signals (e.g., 2.4 GHz, 3.6 GHz, and 4.9/5.0 GHz bands) and standardized protocols for the modulation of the RF signals and the exchanging of information packets (e.g., IEEE 802.11x).

It should be appreciated that examples as will be hereinafter described may be implemented through the execution of instructions, such as instructions stored in the memory 105 or other element, by processor 101 of the device 100 and/or other circuitry of device 100. Particularly, circuitry of device 100, including but not limited to processor 101, may operate under the control of a program, routine, or the execution of instructions to execute methods or processes in accordance with embodiments of the invention. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by device itself and/or some or all of the functions, engines or modules described herein may be performed by another system connected through I/O controller 125 or network interface 110 (wirelessly or wired) to device. Thus, some and/or all of the functions may be performed by another system and the results or intermediate calculations may be transferred back to the device 100. In some embodiments, such other devices may include a server configured to process information in real time or near real time. In some embodiments, the other device is configured to predetermine the results, for example based on a known configuration of the device. Further, one or more of the elements illustrated in FIG. 1 may be omitted from the device 100. For example, one or more of the sensors 130-165 may be omitted in some embodiments.

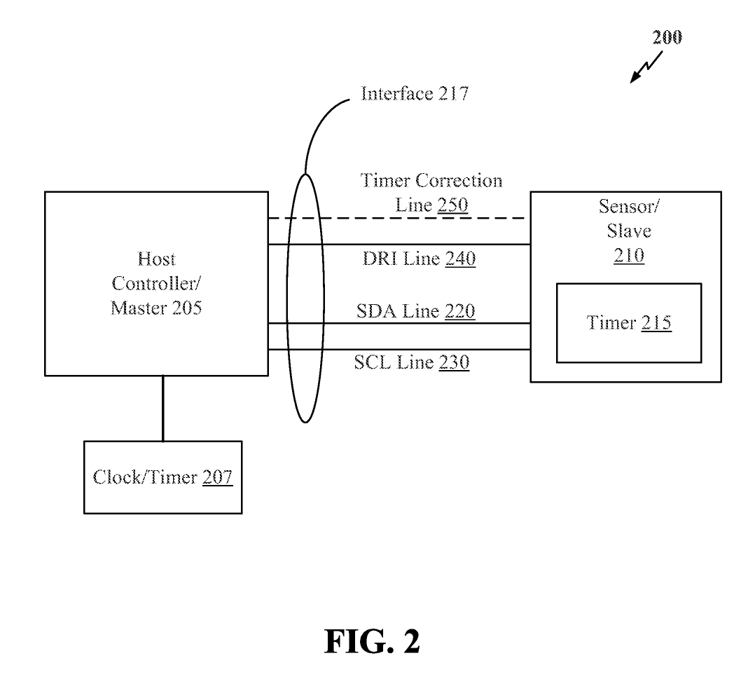

FIG. 2 is block diagram illustrating an exemplary hardware environment 200 in which aspects of the present disclosure may be practiced. A host controller 205 (or master) may be provided to receive and process data samples transferred from a sensor 210 (or any other device that provides sampled data to a host or master), among other functions. In an example, the host controller 205 may be implemented by or within processor 101 of device 100, but is not limited to such and may be implemented separate from processor 101. Sensor 210 may be a sensor of any type, such as those described above, or any device that collects and sends sampled data. The presently disclosed embodiments are not limited by the number of sensors, and more sensors (not shown) may be present. In some embodiments, host controller 205 may be provided with a clock or timer signal from a clock 207. In other embodiments, an internal clock generator may be embedded with controller 205. Sensor 210 includes an internal timer generator 215, which generates a timer signal for timing the collection and transmission of samples by sensor 210. A data connection, bus, or interface 217 links the processor 101 with the sensor 210 and allows for, among other things, timing of the transfer of data between the host controller 205 and the sensor 210. In the example shown in FIG. 2, the data connection may be an Inter IC bus (I²C bus) or an I3C bus including a Serial Data (SDA) line 220 and a Serial Clock (SCL) line 230. Both SDA line 220 and SCL line 230 may be pulled up with pull-up resistors (not shown). The operation of I²C or I3C busses are known in the art, and will not to be described in detail here for sake of brevity.

The data connection may also be a universal asynchronous receiver/transmitter (UART) connection, a Serial Peripheral Interface (SPI) bus, a System Management Bus (SMBus), a Serial Low-power Inter-chip Media Bus (SLIMbus™), a SoundWire bus, a wireless interface. In some embodiments, sensor 210 may have a Data Ready Interrupt (DRI) pin, which may be connected to controller 205 via a DRI line 240. In embodiments where more than one sensors are present, DRI lines from the multiple sensors may be multiplexed before being connected to processor 101. In some other embodiments, in addition to or instead of a DRI pin, sensor 210 may have a dedicated clock correction pin, which may be connected to processor 101 via a clock correction line 250.

Computing device 100 may comprise a sensor 210 including or coupled to a sensor timer 215 and a host controller 205 including or coupled to a clock or timer 207 to: correct the sensor timer 215 for a first time, transfer data from the sensor 210, and correct the sensor timer 215 for a second time, wherein a time interval between two corrections of the sensor timer 215 may be selected such that the sensor timer 215 is sufficiently aligned with the host controller timer 207 over the time interval.

Two methods of transferring data from sensor 210 to host controller 205 are commonly utilized. In the first method, also known as the asynchronous method, a sensor 210 with available data to transfer may notify host controller 205 by issuing a Data Ready Interrupt (DRI) signal through a dedicated DRI pin, which wakes the processor up from the sleep state, and transfers the data when the processor is ready for the data transfer. In the second method, also known as the synchronous method, host controller 205 may wake up from the sleep state spontaneously at predetermined time intervals, and may poll sensor 210 to receive data. The synchronous method is more energy efficient in a device comprising multiple sensors because data transfers from more than one sensor may be consolidated into a single poll and transfer session.

Ideally, assuming a sensor delivers only the most current result, polling a sensor at a frequency that coincides with the sensor's sampling frequency is sufficient to obtain all the data samples collected by the sensor. However, because host controller 205 and sensor 210 do not usually share a clock or timing signal and misalignment of the timing of respective timers may result, some sensor data samples may be lost and some sensor data samples may be read twice even when sensor 210 is polled at its sampling frequency. The phenomenon may be exacerbated by the fact that some sensors may have very poor timer accuracy (i.e., ±15% deviation over the temperature range and from device to device).

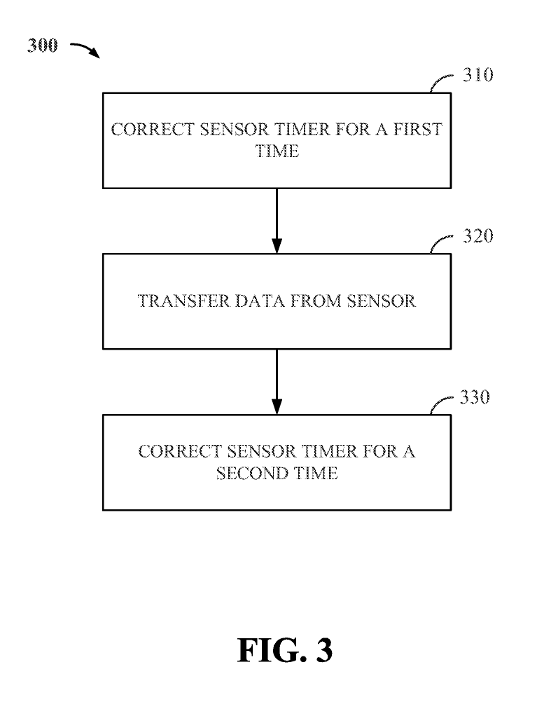

Referring to FIG. 3, a flowchart illustrating an exemplary method 300 for synchronizing sensor timing is shown. At operation 310, the sensor timer may be corrected for a first time. Correcting the sensor timer may comprise applying a timer correction factor to the internal timer on which the sampling events are based, such that the internal sensor timer is sufficiently aligned with the clock signal used by host controller clock or timer 207. The internal sensor timer 215 is sufficiently aligned with the processor clock, on which polling events are based, when it can be guaranteed for a sufficiently long period of time that polling the sensor at a frequency that coincides with the sensor's specified sampling frequency will result in receiving all the sensor data samples, with no data sample being lost and no data sample being read twice. It should be noted that when two timer signals are perfectly aligned, the ratio between their real frequencies is equal to the ratio between their specified frequencies. At operation 320, sensor 210 may be polled by host controller 205, and sensor data samples may be transferred to host controller 205 from sensor 210. Operation 320 may consist of multiple polls and multiple data sample transfers. At operation 330, the sensor clock may be corrected for a second time in the same way it is corrected for the first time in operation 310. The time interval between two corrections of the sensor timer 215 may be selected such that the timer signals remain sufficiently aligned, as defined above, over the interval, inaccuracies of timer signals accumulated over the interval notwithstanding. If the interval selected is too short, energy may be wasted in correcting sensor timers 215 more often than needed. On the other hand, if the interval selected is too long, timer signals may become misaligned and data sample loss or repetition described above may occur.

The time interval between two sensor timer corrections may be referred to as the Phase Time or Time Phase interval (T_Ph). In particular, the Time Phase interval (T_Ph) may be a period of time provided by a host or master controller 205 that indicates a pre-established time duration that is used by the Slaves or Sensors 210 for adjusting their internal timers and the beginning of a sequence of sampling events. The “T” stands for “time” or “period” and “Ph” for “phase”, referring to the fact that the sequence of sampling events takes place within the same time period and begins at the same moment. In a particular aspect, the T_Ph may be defined in terms of or representable as a predetermined number of samples or sampling events in the sequence of sampling events over a T_Ph period. For example, the T_Ph may be defined in terms of 20 sampling events that occur in each T_Ph period.

By performing operations 310 through 330 repeatedly, the internal sensor timer 215 may be kept sufficiently aligned with the host controller clock. In some embodiments, T_Ph may be a common multiple of sampling periods of sensors present. For example, in an embodiment where three sensors having sampling frequencies of 200 Hz, 100 Hz, and 10 Hz (corresponding to sampling periods of 5 ms, 10 ms, and 100 ms), respectively, are present, 100 ms may be selected as the T_Ph. It should be appreciated that synchronizing a plurality of sensors substantially simultaneously using a T_Ph that is a common multiple of sampling periods of the plurality of sensors present aligns the sensor clocks with each other and therefore allows the processor to obtain all samples with the fewest wake windows with the synchronous method. In the above-mentioned example, if the sensor clocks of the three sensors with sampling frequencies of 200 Hz, 100 Hz, and 10 Hz are not aligned with each other, the processor may have to wake up a total of 310 times per second to obtain all samples in the worst case scenario, where the processor receives a single sample from a single sensor in each wake window (200 times per second for the 200 Hz sensor, 100 times per second for the 100 Hz sensor, and 10 times per second for the 10 Hz sensor). On the other hand, if the sensor timers of the three sensors are aligned as described above, the processor needs to wake up only 200 times every second to obtain all samples: the 200 Hz sensor is polled every time the processor wakes up; the 100 Hz sensor is polled every other time the processor wakes up; and the 10 Hz sensor is polled every 20 times the processor wakes up. Reducing the number of wake windows required is desirable because it conserves power and extends battery life. In some embodiments, T_Ph may be approximately 1 second. T_Ph may also be adjusted at run-time in embodiments where clock-related feedback information is provided by sensor 210.

A number of non-limiting methods for correcting the sensor timer 215 have been contemplated. In some embodiments, sensor 210 may receive information relating to the processor clock or timer, derive the timer or clock correction factor, and apply the timer correction factor. In some embodiments, sensor 210 may send information relating to its internal timer or clock to the host controller 205, receive the timer correction factor derived at host controller 205, and apply the timer correction factor.

For embodiments where timer-related information is exchanged between host controller 205 and sensor 210, a number of non-limiting methods for exchanging clock or timer related information have been contemplated. In some embodiments, the clock or timer information may be transferred using DRI line 240. In some embodiments, the clock or timer information may be transferred using a dedicated clock or timer correction line 250. In yet some other embodiments, the clock or timer information may be transferred using a regular data connection between processor 101 and sensor 210, such as an I²C or I3C bus described above.

In a first group of embodiments, sensor 210 may receive information relating to the processor timer or clock 207, derive the timer correction factor, and apply the timer correction factor when the sensor timer 215 is being corrected.

In one embodiment, when the sensor timer 215 is being corrected, host controller 205 may transmit a burst of pulses consisting of a predetermined number of pulses to sensor 210. The burst of pulses may be derived from the host controller timer and its frequency may be dependent on that of the host controller timer. The burst need last only a relatively short period of time. Here, sensor 210 may be configured a priori with the expected frequency of the burst. Once sensor 210 receives the burst, it may compare the frequency of the burst received with the expected frequency, derive a timer correction factor accordingly, and apply the timer correction factor to correct the internal sensor timer 215.

In another embodiment, when the sensor timer 215 is being corrected, host controller 205 may transmit two pulses to sensor 210, where the pulses are spaced by a predetermined time interval as measured by the processor timer. The time interval is chosen such that it can be reliably used to derive a timer correction factor to correct the sensor timer 215. This time interval may be referred to as the Frequency Time interval (T_Fq). In some embodiments, T_Fq may be in the range of a few milliseconds. In some embodiments, T_Fq is chosen to coincide with the shortest sensor sampling period present. In some other embodiments, T_Fq may be chosen to be as long as T_Ph. For example, T_Fq may be 1 second. Here, sensor 210 may be configured a priori with the predetermined T_Fq. Once sensor 210 receives the two pulses, it may compare the duration of the time interval bookended by the two pulses received, as measured by the sensor timer, with the predetermined T_Fq, also as measured by the sensor timer, derive a timer correction factor accordingly, and apply the timer correction factor to correct the internal sensor timer.

In yet another embodiment, when the sensor timer is being corrected, host controller 205 may transmit timer correction messages to sensor 210 over the data connection between host controller 205 and sensor 210 such that two identifiable significant edges generated during a transmission of timer correction messages are spaced by a predetermined T_Fq, as measured by the processor timer. As described above, the data connection between host controller 205 and sensor 210 may be an I²C bus or I3C bus. It may also be a UART bus connection, an SPI bus, or any other type of connection suitable for transferring data between a controller and a sensor. The predetermined T_Fq may be the same as described above. Here, sensor 210 may be configured a priori with the predetermined T_Fq. Once sensor 210 receives the timer correction messages, it may compare the duration of the time interval bookended by the two identifiable significant edges included with the timer correction messages, as measured by the sensor timer 215, with the predetermined T_Fq, also as measured by the sensor timer, derive a timer correction factor accordingly, and apply the timer correction factor to correct the internal sensor timer.

For example, in an embodiment where the data connection between host controller 205 and sensor 210 is an I²C or I3C bus, two clock correction messages may be transmitted. These two timer correction messages may be referred to as MS1 and MS2, respectively. T_Fq may be bookended by the falling edge on SDA line 220 in the START condition for MS1 and the falling edge on SDA line 220 in the START condition for MS2, or may alternatively be bookended by the rising edge on SDA line 220 in the STOP condition for MS1 and the falling edge on SDA line 220 in the START condition for MS2. In embodiments where T_Fq is chosen to be as long as T_Ph, only one timer correction message, e.g., MS1, may be required, and the MS1 message may be transmitted by processor 101, for example, at the beginning of each T_Ph. Thus, the time period T_Fq that is equal to T_Ph may be bookended by, for example, in one embodiment, the falling edges on SDA line 220 in the START condition for two consecutive MS1 messages. Of course, the invention is not limited by the examples provided herein. Moreover, the use of the I²C or I3C bus for the purpose of correcting the sensor timer 215 also allows for supplementary error correction procedures, fault detections, and abort commands, etc. For example, sensor 210 may transmit a timestamp or a message including time deviation information and host controller 205 may correct the subsequent streams of data accordingly. By utilizing this procedure, the accuracy requirements of T_Ph may be relaxed. Other ways of exploiting the bi-directional communication abilities of the I²C or I3C bus for timer correction purposes have also been contemplated.

In a second group of embodiments, sensor 210 may send information relating to its internal timer to host controller 205, receive the timer correction factor derived at host controller 205, and apply the timer correction factor when the sensor timer 215 is being corrected.

In one embodiment, when the sensor timer 215 is being corrected, sensor 210 may transmit two pulses spaced by a predetermined T_Fq or Output Data Rate (ODR) period as measured by the sensor timer to host controller 205. The predetermined T_Fq may be the same as described above. Here, host controller 205 may be configured a priori with the predetermined T_Fq. Once host controller 205 receives the two pulses, it may compare the duration of the time interval bookended by the two pulses received, as measured by the processor timer, with the predetermined T_Fq, also as measured by the processor timer, derive a timer correction factor accordingly, and transmit the timer correction factor to sensor 210 via the interface 217 between host controller 205 and sensor 210, such as an I²C or I3C bus. Sensor 210 then may receive the timer correction factor and apply it.

In a third group of embodiments, no timer correction factor is used. In these embodiments, the processor timer, or a signal derived from the processor timer, may be provided to sensor 210, and sensor 210 may base the sampling events directly on the processor timer or the signal derived from the processor timer. The processor timer or the signal derived from the processor timer may be transmitted using a dedicated line, a DRI line 240, or may be transmitted within messages transferred on the data connection between processor 101 and sensor 210.

In one embodiment, host controller 205 may generate a sampling timer signal based on the processor timer, and transmit the sampling timer to sensor 210. The frequency of the sampling timer may be the same as the sampling frequency of sensor 210. Sensor 210 may be configured to ignore its internal sensor timer and collect a sample only when it encounters a pulse in the sampling timer signal transmitted by host controller 205.

In one embodiment where multiple sensors are present, the frequency of the sampling timer signal generated by processor 101 may be selected such that the frequency of the sampling timer signal is a common multiple of sampling frequencies of sensors present. For example, for an embodiment where three sensors having sampling frequencies of 200 Hz, 100 Hz, and 10 Hz, respectively, are present, processor 101 may generate a sampling timer signal with a frequency of 200 Hz based on the processor timer and transmit the sampling timer signal to all three sensors. Then, the sensor with the 200 Hz sampling frequency may be configured to collect a sample at every pulse it encounters in the sampling timer signal: the sensor with the 100 Hz sampling frequency may be configured to collect a sample at every other pulse it encounters in the sampling timer signal; and the sensor with the 10 Hz sampling frequency may be configured to collect a sample at every 20^{th} pulse it encounters in the sampling timer signal.

It should be appreciated that because the sampling timer is based on the host controller timer, sampling events of sensor 210 and polling events of host controller 205 may always be aligned. It should also be appreciated that in some embodiments, the sampling timer signal may serve as the polling signal as well at the same time. In another embodiment, the processor timer may be directly provided to sensor 210, and sensor 210 may base the sampling events on the processor timer instead of its internal sensor timer.

By utilizing the exemplary methods for synchronizing sensor timers described herein, a controller may coordinate timer corrections for sensors and receive all sensor data samples from multiple sensors in batches in an energy-efficient synchronous mode, without wasting energy in polling the sensors at a frequency that is higher than necessary.

A method for determining the frequency of re-synchronizing sensors by transmitting a single set of timer correction messages comprising one or more messages from the processor to the sensors has been contemplated. It should be appreciated that the frequency of re-synchronizing sensors is the multiplicative inverse or reciprocal of T_Ph.

According to further aspects of the present disclosure, methods and apparatus are disclosed that utilize specific hardware events (or hardware and software in another example) for time-controlled synchronizing events. The specific hardware events may depend on the transport system or interface used, e.g., the event would differ between different bus interfaces such as I2C, I3C, SPI, etc., as well as wireless interfaces between controller/master devices and sensor/slave devices. Nonetheless, the events may be identified with specific set of commands and data. In one example, such commands are sent within a same I2C or I3C transaction, for example, that is used for an otherwise normal data exchange (e.g., reading data from sensors): as such, the energy required is negligible. The time synchronizing events, in particular, may be sent by a host controller at T_Ph intervals. In an aspect, the time synchronizing event may be chosen among hardware (HW) events that are known to occur on a transport system or interface. In a particular aspect with respect to busses such as I²C or I3C, there are several start (START) conditions that are known to occur on an interface that may be used as time synchronizing events, although the HW event is not limited to such. In an aspect, regardless of the transport system or interface, the HW event may consist of a mutually identifiable message known to both the host controller and the sensors a priori. Thus, the sensors (and host controller) may identify the T_Ph intervals beginning when the mutually identifiable HW event occurs on the transport system or interface.

As discussed above, in some systems different sensors or other devices will sample their data at different times. This may happen even when setting a common sampling frequency because the timers or oscillators in the different sensor devices are typically not accurate enough to not eventually drift apart. A synchronous time control mechanism or HW event proposed in certain systems (e.g., an I²C bus or an I3C bus system according to the MIPI I3C^{SM} specification) provides a way for the controller to form a synchronization pulse or message, called a SYNC Tick (ST). This way, even with variances in sensor timers or oscillators, the sampling will be performed very close together in time, allowing for their preparation and activation of the sampling mechanism. Furthermore, the HW is mutually agreed upon by the host controller/master and sensor/slave, and is the event that is to be timestamped by the slave/sensor against its time base (i.e., its internal timer/counter). In other examples, the HW event could be the start of the communication on the line, which for I²C, I3C, or System Management Bus (SMBus), as examples, could be chosen as one of the transmission starts that will be the moment in time that is to be recorded/timestamped by the sensor/slave. For other interfaces, the HW event may be some other mechanism. As an example in SPI, the HW event could be the CS line going LOW for the transmission. As another example, assuming a very fast interface with respect to the timing of a HW event, the moment could be even the ST message itself, as in the case of SPI, where the message takes only one microsecond, and thus would adequate for synchronizing a 1 second long T_Ph.

In another aspect, it is noted that the ST is generally a message that is configured to validate, and actually identify which of the many similar HW events present on an interface is the one that should be used for further calculation of the correct start of T_Ph. The HW event may be any number of known events. As an example of a HW event, the ST itself may constitute the agreed upon event in an SPI transport, where the ST message only take 1 microsecond of time altogether, which would be sufficiently short for a synchronizing event. Other examples of HW events may be edges of the pulses on the transport medium. Some HW events may have a supplementary characteristic, such as being the last edge of a defined set of pulses. In wireless systems, the starting of communications on the wireless interface may constitute a HW event. In another example for wireless interfaces, the HW events may be communicated and through the use of special or dedicated communications or communication channels particular to various known wireless protocols. Additionally, the DT is a message as well. With these three elements; i.e., the HW event, the ST identifying message and the DT validating and correcting message, the presently disclosed synchronization procedure may be accomplished. And because the messages (e.g., a HW event, an ST and a DT) can be sent some time after the correct start of T_Ph, the method covers all uncertainties of the whole system. For purposes of this disclosure, it is noted that the combination of the HW event and the ST message identifying the HW event may be referred to collectively as a “synchronization message.” In aspects the HW event may be subsumed into the ST message where the starting edge or time of the ST message constitutes the HW event.

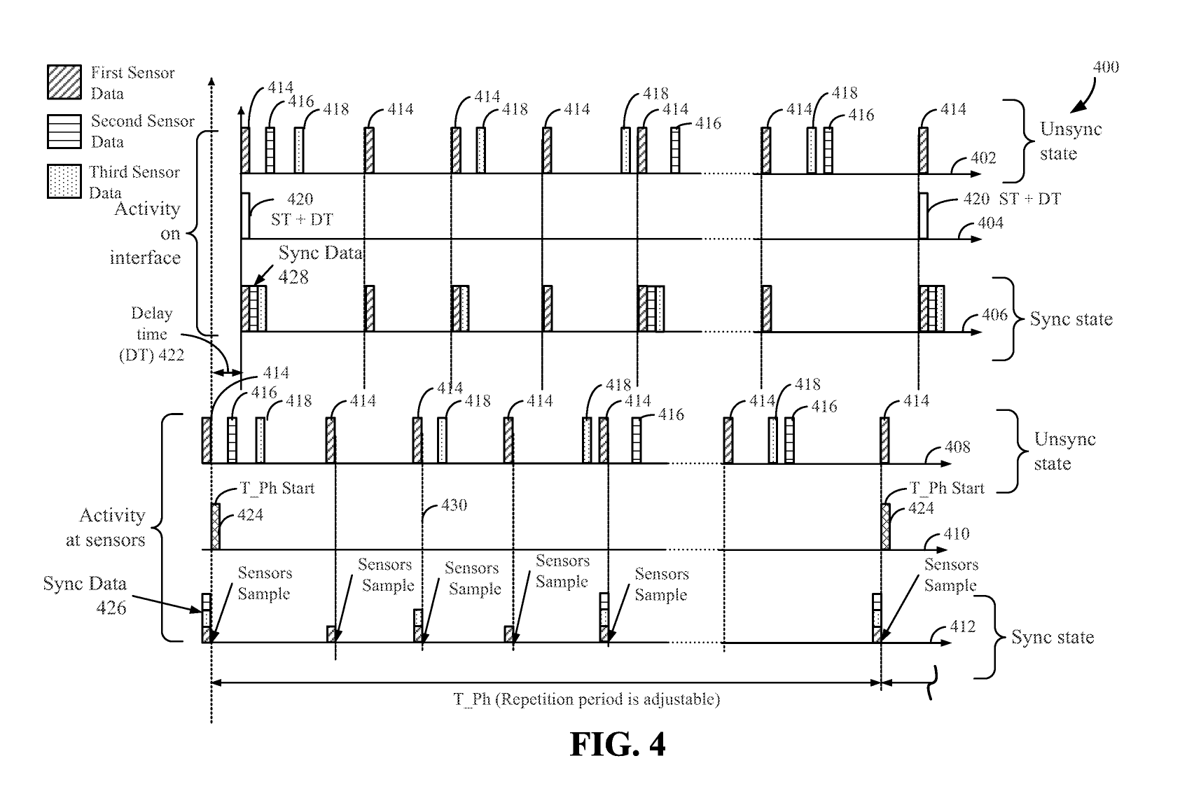

FIG. 4 illustrates an exemplary system timing diagram 400 of activity on an interface, where the diagram shows a transition from unsynchronized or random sampling timing in a system to a synchronized timing state for sampling over T_Ph time periods. It is noted that the interface is not limited to a particular transport system, and may include wired busses or wireless interfaces in other examples. In the example of FIG. 4 three sensors are assumed, but those skilled in the art will appreciate that this is merely exemplary and that fewer or more sensors in a system are possible and that the concepts disclosed herein apply to one or more sensors. The top three timelines 402, 404, and 406 in FIG. 4 illustrate activity visible on an interface, such as an I²C, I3C, SPI, etc. interface, and include commands sent by a host controller to the various sensors or other devices providing data samples on the interface and data samples from various sensors or other devices. The timelines 402, 404, and 406 also illustrate a change in time or states from the unsynchronized state 402 to the synchronized state 406. The bottom three timelines 408, 410, and 412 illustrate data availability inside the individual sensors (or other devices providing data). As with the timelines 402, 404, 406, timelines 408, 410, and 412 also illustrate a change in time or states from the unsynchronized state 408 to the synchronized state 412. It is noted that the timeline of timeline 402 corresponds to a time before synchronization processes have been effectuated and timeline 406 corresponds to a time after synchronization processes are effectuated.

As may be seen in timeline 402, sensor data from the different sensors connected by the interface (i.e., data 414 for the first sensor, data 416 for the second sensor, and data 418 for the third sensor) is not synchronized since the data is sent at various and seemingly random times on the interface, with the sensors running at their own respective ODRs and unrelated timers. In certain aspects of this unsynchronized state, a host controller would awaken for each sensor's DRI events, which wastes a significant amount of system energy. Similarly, timeline 408 shows the unsynchronized state of the sensor data 414, 416, 418 at the various sensors.

Timeline 404 illustrates that the host controller may transmit information signals or messages 420 as the time synchronization event, which are sent at the start of each T_Ph period to the various sensors coupled with the interface. According to an aspect, each of the information messages 420 may consist of a HW event such as a synchronization edge, synchronization pulse, or synchronization message (i.e., the Sync Tick or “ST” message), as well as a delay time (DT) message, which will be discussed in more detail below. For purposes of this disclosure, the term “information message” used herein connotes the combined ST+DT message, and it is to be also understood that the “information message” 420 may be referred to herein as an ST+DT message. The ST edge or message of message 420, although not shown in FIG. 4 as being separate from the information message 420 from the DT information, would occur at the start of the message 420 and may be a distinct from the DT message, or may alternatively be configured such that the rising edge of information message 420 provides the ST messaging, with the remainder consisting of the DT information. The information messages 420 are usable by the sensors to correct their timing; i.e., correct their timers for purposes of synchronization with the host controller.

Ideally, the time period between the information messages 420 should be the time phase period T_Ph. Due to the hardware and software overhead mentioned earlier, however, there may be a delay between the expected beginning of new T_Ph periods and the transmissions of the information messages 420, which is termed herein as the Delay Time, or “DT” illustrated in FIG. 4 at reference 422. To compensate for the potential inaccuracies that may result from unpredictable and variable starts of the T_Ph period (and the issuance of the ST edge or message), the DT period may be measured by the host controller, and this measured time period communicated by the host controller with as the DT portion of information message 420. Furthermore in an aspect, the DT portion of an information message 420 is transmitted after the transmission of the ST edge or message portion of the information message 420. According to an example of an I3C interface, the information message 420 may be transmitted in-band, thus requiring only two lines (e.g., SDA and SCL). Furthermore, the DT message or command may be configured to provide the number of time units by which the START Condition has been delayed on a transport system or medium (e.g., an I²C or I3C Bus) relative to perfectly in-sync timing. The DT message may use one data byte, where the Most Significant Bit (MSB) of the data byte is a flag indicating whether overflow of a time delay counter has occurred. A value 1b′0, for example, would indicate no overflow. The lower 7 bits of the data byte may be configured to contain a valid timer value. A value 1b′1 in the MSB would indicates that an overflow has occurred and that the lower 7 bits of the data byte do not contain a valid value, and that the sensor or slave should abort the current Synchronization Procedure.

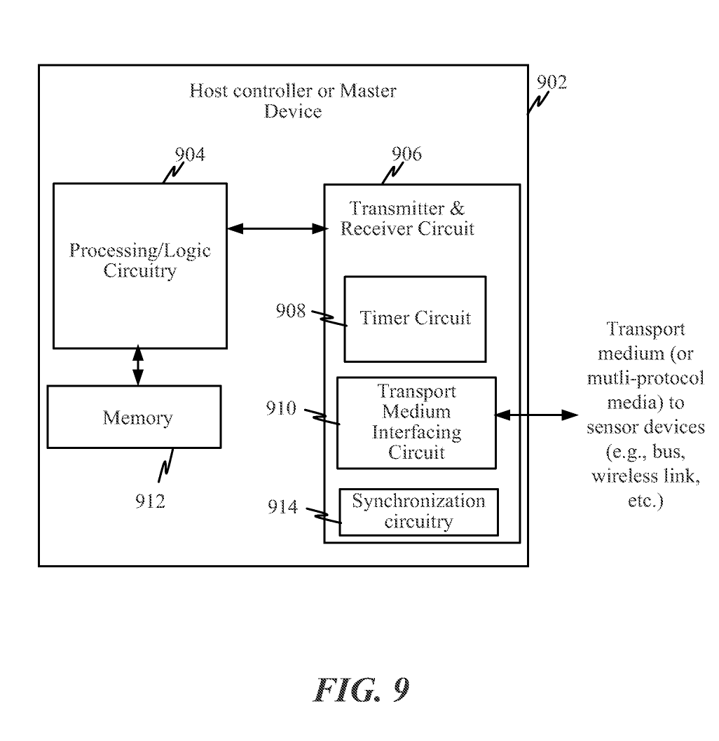

It is noted here that in one example the DT is measured by the host controller with reference to the internal clock or timer of the host controller. In one example, the host controller may utilize a predetermined time (e.g., a “watermark”), or a coincidence time on its running timer, which corresponds to the perfect time for starting T_Ph (termed “Starting T_Ph time”). The host controller may then send a command to an interface controller for sending the ST message to the sensor or slave devices (e.g., transport medium interfacing circuit 910 shown in FIG. 9 to be discussed later). This interface controller would then schedule the transmission, and eventually starts the transmission when the interface is available. The interface controller records the real time moment (termed “Real T_Ph time”) when the transmission started against the host controller time base (e.g., this timing could be determined based on the same running timer that the host controller used for determining the watermark or coincidence time, or a derivative of that timer). Regardless, the two time information (i.e., the “Starting T_Ph time” and the “Real T_Ph time”) are related and are based on the same time base, namely the host controller's time base. The host controller then calculates the difference between “Starting T_Ph time” and the “Real T_Ph time” and then expresses that difference in time units as previously agreed with the slave/sensor, formats the DT message, and sends it to the slave/sensor across the same interface. Thus, the slave/sensor can deduct the communicated DT from the time it receives the real time HW event (i.e., at the “Real T_Ph time”), and therefore arrive at the Starting T_Ph time when the T_Ph should have actually been started, against slave/sensor time base (i.e., the timer/counter of the sensor). Furthermore, the information indicating the Delay Time period may indicate that the delay period is approximately 1/n as long as a time phase period T_Ph, where n is a power of two (e.g., 1, 2, 4, 8 . . . ). Based on the timing of the synchronization message and the information indicative of the Delay Time periods, the sensors/slaves may determine the expected beginning of new T_Ph periods.

Based on the timing of the information message 420 including the Delay Time information, sensors receiving this information may determine the expected beginning of a next or new T_Ph period, indicated by pulse or timestamp 424 in timeline 410, for example, showing processing of the information message 420 has occurred. With the determined start of the next T_Ph period the sensors may then transmit data at particular predetermined repetitions or system awake intervals within the T_Ph period as may be seen in timeline 412. When the sensors' timers are synchronized, sensor data may be transmitted at each timestamp or sample frequency of each of the synchronized sensors as may be seen in timeline 412. Thus, the sensor data is synchronized (see generally 426 in FIG. 4) and this data will be synchronized on the interface (see 428 in timeline 406, as an example) and will be able to be read more efficiently by the host controller as the data sets are read within a same system awake interval during which sensor polling is accomplished. It is further noted that according to an aspect the system awake periods are adjustable.

FIG. 4 illustrates that a synchronized system affords adjust of the frequency and phase of the sensors' sampling periods. The host controller or master sends the synchronization information (i.e., information message 420 or Synchronization event) with a repetition period of T_Ph. As discussed before, the time phase period T_Ph may be a relatively large time interval, such as 1 second, and is exactly divisible by the Least Common Multiple of the sampling periods of the sensors coupled to the host controller. In practical cases however, it is not always possible to have a suitable correspondence between different Slaves/Sensors and their different ODRs, such that a Least Common Multiple would have a useful value. In such cases, the synchronization process could either adjust some of the ODRs or, in the worst case, synchronize the sensors in more, but smaller groups.

It is further noted that for the synchronized timeline examples in FIG. 4, after the host controller transmits the phase and frequency information (T_Ph), the sensors will have their data ready at mutually synchronized moments as illustrated in timeline 412. This reduces the number of host controller awake periods and minimizes the expended energy needed to read the desired sensor data.

It is also noted that a host controller (e.g., 205) may be configured to transmit various commands and corresponding data over the interface 217, such as an I2C or I3C interface. In a particular aspect, a host controller will transmit an Output Data Rate (ODR) command and data to particular sensors or devices that sets or establishes the running output data rate for a sensor(s). The ODR value indicates the number of samples taken by a sensor in a given period of time and is also specific to each particular sensor or device sampling and transmitting data over the interface. Additionally, a host controller also issues a command and data that communicates the time phase period T_Ph. In an aspect, the T_Ph may be expressed in the number of sampling periods of a chosen ODR. Another command and data that may be issued by the host controller is a resolution ratio (RR) representing the resolution ratio of the delay time (DT). The RR may be expressed in the number of divisions of a selected power of 2 of the T_Ph time, as will be discussed later in more detail.

As mentioned before, the ST and DT could be sent across many different types of interfaces and the methodology disclosed herein is not limited to any one type of interface. In a further aspect the methodology may be used on several or multiple interfaces as well as multiple interface protocols where several sensors may be synchronized against the internal time base of the host controller. This is possible because the HW event (i.e., the ST and/or the ST and DT together or paired) do not need to be sent at an exact or precise timing with regard to the correct start of T_Ph due to the measurement and transmission of the delay time.

As discussed above, the start of a T_Ph interval may correspond to a time when most of the sensors would collect data simultaneously, and the sampling moments of several sensors should coincide at least once during one T_Ph period. These coincident sampling moments allows the data transfer from all the sensors to occur during a same transaction, as may be also seen in timeline 412, for example, and sampling moments may be seen at the vertical dashed lines in FIG. 4 (See e.g., line 430 in FIG. 4). Also, in an aspect the T_Ph value is generally chosen such that the sensors' timers keep 0.1% accuracy with respect to T_Ph duration, which generally is about one (1) second.

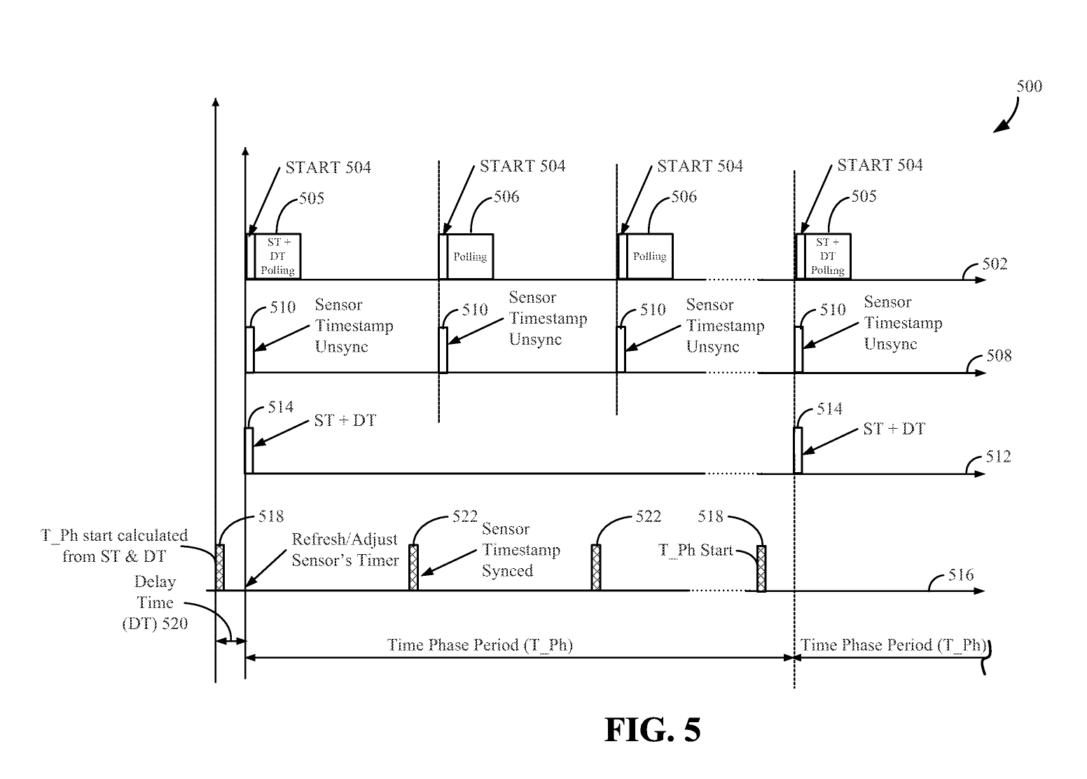

FIG. 5 illustrates a timeline diagram 500 showing an example of a synchronization procedure on an interface, such as and I2C or I3C Bus. In particular, FIG. 5 illustrates a timeline of communications over the interface between a controller (e.g., host controller 205) and a sensor (e.g., 210) in which the timing of the sensor is adjusted to provide efficiency in coordinating multiple sensors and to guarantee that sensor reads do not duplicate data or miss desired data. As part of this sensor timing adjustment, the example of FIG. 5 utilizes the information message (e.g., message 420) including an ST message followed by or paired with a delay time DT message for synchronization of sensor timers to the host controller.

Timeline 502 shows read events of by a host controller (e.g., 205) of communications emanating from a sensor (e.g., 210) on the interface. Timeline 502 shows the communication including a START 504 event, in the case of I2C or I3C, and then the data and control information 506 from the sensor. A first portion of information 505 may include the Sync Tick (ST) and the Delay Time (DT), with the remainder of the communication information including typical communications exchanging polled data and control information. According to an aspect, if the ST is part of I2C or I3C communications, the sensor internally records when the ST occurs and uses that information if it is followed by a command indicating that it is used as a synchronization pulse or event. In another aspect, the synchronization events are mutually identifiable hardware events between controller and sensor, which may be determined a priori. In an aspect, the hardware event may be one of various START conditions known to I2C or I3C interfaces, such as a START condition defined by a falling edge of the SDA line, but the event is certainly not limited to such. Subsequent communications 506 within the T_Ph period may include polling or other commands/messages.

In particular, the messages 506 including polling messages elicit a response from the sensors in which the sensors may transmit sensor sample data back to the host controller. The sensors may also transmit timestamps indicating the transmission time based on their own respective sensor timers. The timestamps may be in any suitable form, e.g., as part of an I²C or I3C bus response message along with the sensor sample data, as a dedicated message if a protocol faster than I²C or I3C (e.g., SPI) is used, or on a separate connection between the processor and the sensor.

The next timeline 508 illustrates the timing when the sensor timestamps 510 are recorded on the sensor itself, which corresponds in time to the START messaging 504. These timestamps 510 in timeline 508 represent an unsynchronized operation. In an aspect, the sensor may eventually transmit these timestamps back to the host controller along with any corresponding sensor data. These timestamps 510 may be configured in many forms, such as part of I²C or I3C communication (i.e., on SDA and SCL lines), on a separate line, or even a complete message if the communication system is faster than I²C, such as SPI as one example.

Timeline 512 shows the ST and DT message 514 (e.g., the information message 420 as discussed earlier) that is used for synchronizing the host controller and the sensor. The ST message is validated by the DT message, which gives the time delay that is usable by a sensor for timing correction. It is noted here that the correction for the delay arising in the host controller is different from sensor clock rate correction, which is determined within the sensor based upon the time between ST pulses. In another aspect, it is noted that the ST message and DT message in message 514 may be distinguished from one another by setting different values in a Defining Byte field for each message.

As described above, the host controller may determine or measure the delay time (DT) 520, which is the time from an expected start of a T_Ph period (sequence period) as indicated on timeline 516 at timestamp pulse 518 at T_Ph start that is in synchronization. Additional sensor timestamps 522 during the T_Ph period are synched with the host controller. The time correction communicated by the DT message accounts for the time between the start of the T_Ph and when the ST message is sent out on the interface. As described before, this delay may occur because there is hardware and software overhead in the host controller. The hardware overhead is usually known ahead of time from the latency of digital logic of the host controller. On the other hand, the software overhead latency may be less stable and may arise from competing priorities in the operating system or the control software. For example, the software may be handling priority interrupts during the time when the ST is about to be sent. This can cause sending of the ST to be delayed. Furthermore, these delays can change from cycle to cycle. Thus, sending the measured DT 520 with the ST affords the ability for sensors to adapt to the delay of the beginning of the T_Ph period and the sending of the ST. Thus, the DT message effectively qualifies each ST time stamp. According to other aspects, it is noted that the ST message is preferably sent as soon after a START Condition (and, for a Direct Message, the Slave Address) as possible, providing enough time for the DT Message to be sent and received. Additionally, the DT Message should arrive before a next shortest polling time window, as will be discussed in more detail later. According to still further aspects, the DT Message may contain either a time delay between the START Condition and the required T_Ph Start, or else an abort order for the current synchronization window.

In operation, each sensor may be configured to record the value of its internal timer at the moment when the HW event is detected. In an example the SDA falling edge of the START Condition could be the HW event to be detected on the interface, in the example of using an I²C or I3C Bus. In such case, a record of the last START may be stored in a register or similar device for storing a value. When the sensor recognizes either its slave address or a Broadcast command, and the ST message, each sensor or slave device is configured to then use the stored START time as a reference for the start time of the new T_Ph period. Then, upon recognizing the subsequent DT Message, which is part of the information message (e.g., 420 or 514), each sensor or slave device may either correct the T_Ph start time and T_Ph duration (if needed) with respect to its internal timer, or aborts the current synchronization procedure, preserving the internal timer's running parameters. When the T_Ph interval expires (e.g., after approximately 1.0 second in one example) the host controller or master repeats the synchronization event by then sending a next ST message followed by a DT message in the manner described above.

During configuration or set up of a system to implement the synchronized timing of FIG. 5, various commands may be issued by a master or host controller (e.g., 205) to the sensors (e.g., sensor/slave 210) in particular I2C and I3C systems, for example, although the functionalities thereof are not necessarily limited to I2C and I3C systems. As discussed before, the host controller issues an Output Data Rate (ODR) command for each sensor. In an aspect, the ODR command may communicate to a sensor the running ODR. In another aspect the ODR command code may be a single byte (0xXX) along with another byte of sensor specific data.

Another parameter during configuration is the command to set the duration of T_Ph time period (i.e., the Synchronization Event repetition period or synchronization period), which may also be referred to as the TPH command. This command sets the repetition rate of the T_Ph. In an aspect the ST message may include this TPH command code within the Defining Byte field, followed by specific data byte(s) concerning the particular time settings or values.

Yet another command that may be used during configured is a time unit (TU) command, which may be specific to each or all sensors. This command sets the value of the time unit transferred to the sensor or slave devices. In an aspect the ST message may include this TPH command code within the Defining Byte field, followed by specific data byte(s) concerning the particular time settings or values.

Additionally, another command during configuration of a system is the resolution ratio (RR) command sent by the host controller to the sensors. The resolution ratio command provides a division factor that is applied for calculating resolution steps of the T_Ph time for the DT command. The use of relative division of the T_Ph for transmitting the delay time avoids the need for either the host controller or the sensors to know each-others' real timer or clock value.

The calculation of a T_Ph resolution step is determined by multiplying the corresponding T_Ph time period by the RR. The RR, as described before, is expressed in the number of divisions by a selected inverse powers of 2 of the T_Ph time. As an example, the RR values may be expressed as 2^{-x} where x may be integer values from 11 to 14 (thus, the RR values range from 2⁻¹¹ to 2⁻¹⁴). In terms of the structure of the RR command or message, the two least significant bits (LSBs) in the RR message can used to indicate to the sensors which T_Ph division factor is used for calculating the time resolution steps from integer values 11 to value 14 that are inverse powers of 2 (e.g., 2′b00 [symbol] 2̂(−11), 2′b01 [symbol] 2̂(−12), 2′b10 [symbol] 2̂(−13) 2′b11 [symbol] 2̂(−14)). Thus, if a T_Ph period is assumed to be 1 second (i.e., 1000 ms) and the RR value is set at 2⁻¹¹, for example, the resolution step time would be 1000 ms×2⁻¹¹ or 488 μs. Since the division factor is expressed as an integer power of two, it is noted the multiplying operation is a simple right shift by the same number of positions as the positive integer exponent of the division value. In an aspect, the DT message may be constructed with one byte such that 7 bits could be used for communicating the delay steps and a most significant bit (MSB) would indicate an abort (although the message is not necessarily limited to one byte of data). Thus, the absolute maximum delay time would be a time period that corresponds to 127 resolution steps. Based on the resolution step time determined as a division factor of the T_Ph period and the predetermined number of resolution steps for a maximum delay time (DT) in which the ST+DT message should be transmitted, the maximum delay time may be computed. For example, if the resolution step time is 488 μs from the example above, then the maximum DT correction range would be 488 μs×127 or 62.01 ms. Table I below illustrates examples of various numbers of maximum ST+DT delay times (or DT correction range) given different T_Ph periods and RR values from 11 to 14.

TABLE 1

| | | | | Max ST delay |
|---|---|---|---|---|
| | | | Max ST delay | for DT = 127 |
| | | | for DT = 127 | RR steps |
| T_Ph (ms) | 2^{(-x)} | RR step (μs) | RR steps (ms) | (% T_Ph) |
| 200 | 11 | 98 | 12.40 | 6.20% |
| 200 | 12 | 49 | 6.20 | 3.10% |
| 200 | 13 | 24 | 3.10 | 1.55% |
| 200 | 14 | 12 | 1.55 | 0.78% |
| 500 | 11 | 244 | 31.01 | 6.20% |
| 500 | 12 | 122 | 15.50 | 3.10% |
| 500 | 13 | 61 | 7.75 | 1.55% |
| 500 | 14 | 31 | 3.88 | 0.78% |
| 1000 | 11 | 488 | 62.01 | 6.20% |
| 1000 | 12 | 244 | 31.01 | 3.10% |
| 1000 | 13 | 122 | 15.50 | 1.55% |
| 1000 | 14 | 61 | 7.75 | 0.78% |

It is noted that it in particular systems it is essential that the sensors have data available, even if an ST+DT message cannot be sent or the system is in an error state. This is so because the sensor data could be necessary for other devices or processes not directly under the host controller's control. Since the present method provides that the ST and DT are paired together and acknowledged as such by the sensor device, if the ST command cannot be given inside a DT correction range, it will have to be provided much later. In such case, the ST message must be followed by the DT with the abort sync order. Subsequently, a correct ST will follow validated by its paired DT.

It is noted here that the RR provides a compact way of expressing the delay time, suitable for any real time units on which the timers of the host controller/master and sensor/slave are based. By specifying the DT in divisions of the power of two numbers of the whole T_Ph, the resolution of the result is implicitly set. In contrast to the efficiency of using the RR to express the DT, it would not be very useful or efficient to express the DT in milliseconds where the T_Ph is 200 ms, or to express DT in microseconds for a T_Ph of 1 second or longer.

Other factors affecting operation of the synchronization disclosed herein include the consideration that the START event of the ST+DT message must arrive on the bus at least after an expected drift of the synchronized timers to catch the slowest possible sensor or slave. Furthermore, due to host controller uncertainty due to hardware, firmware, and software lag, where this uncertainty is termed “jitter” herein, the SDA falling edge for a START event for the ST+DT message could come even later. However, the START event condition of the ST+DT message cannot come later than a timing acceptable to read the correct data; i.e., the read needs to occur before new data starts filling the output registers or a FIFO buffer at the sensors. Accordingly, methods and apparatus are also contemplated for ensuring that drift of the synchronized timers and host controller jitter is accounted for and mitigated.

In an aspect, the term “jitter” may connote the sum of the statistical uncertainty of the host controller issuing the ST message at an ideal or expected time (e.g., if the uncertainty is ±1 ms, then the total uncertainty is 1 ms+1 ms=2 ms for the whole interval to cover all the possible variations). Additionally, there is a range of timer timings on sensors, which may be due to jitter including quantization errors. This range of timings may be expressed as a percentage of the T_Ph period measured in the timer of the host controller. For a given jitter of the whole system, a maximum T_Ph can be determined.

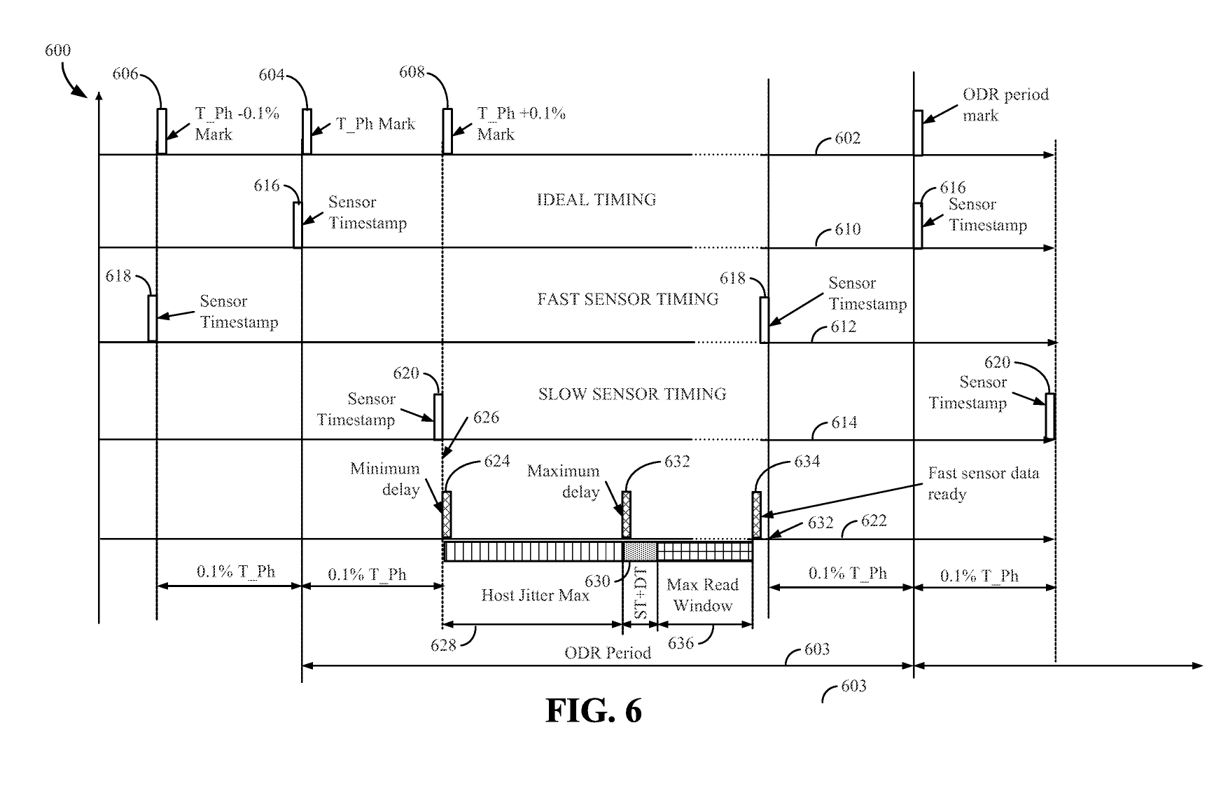

FIG. 6 illustrates a timeline diagram 600 showing setting of polling timing by accounting for jitter and synchronization messaging timing. In particular, FIG. 6 illustrates the effects of jitter on sensor synchronization and polling, and the determination of a maximum read window for ensuring proper polling or reading of data from sensors in a system. The first timelines 602 illustrates shows three possible T_Ph period marks 604, 606, 608 at the beginning of an output data rate (ODR) period or polling period 603. The mark 604 represents an ideal timing point, whereas mark 606 and 608 represent the fast and slow limits, respectively (e.g., −0.1% of the T_Ph period at mark 606 and +0.1% of the T_Ph period at mark 608, as merely one example). It is noted that the ideal, fast, and slow marks are only shown for illustration purposes as a visualization of where these timings would occur. The next three timelines 610, 612, and 614 represent ideal, fast, and slow timers or clocks on a sensor where the deviations fast or slow from the ideal represents the range of acceptability for a sensor. The amount of time the sensor time stamp is off in time (i.e., the fast timestamp 618, the ideal timestamp 616, and the slow timestamp 620) is determined by the timer or clock generation of the sensor. This timing can be affected by temperature, supply voltage, and other elements of the sensor's operation.

Timeline 622 illustrates times that the host controller may poll the sensor by taking into consideration the different situations of ideal, fast, or slow sensor timing. The minimum delay to start polling as shown by pulse 624 must be late enough to ensure that even slow sensor timing has completed data sampling as illustrated by the pulse timing 624 occurring in time just after the timestamp 620 of the slow sensor timing as may be seen at time point 626. This timing would only be possible, however, if the host controller could guarantee polling at that exact time. As mentioned before, however, the host controller itself has a variation in when it is available to actually effect polling due to delays in the hardware, firmware, and software. This variation is shown as the Host Jitter Maximum 628, where this maximum jitter represents the longest possible delay time, the end of which is the illustrated as a maximum delay timing 630 for the ST+DT pulse. The Host Jitter Maximum 628 time period may be known a priori or based on measurements or calculations performed by the host controller.

After the host jitter maximum 628 time has elapsed, the host controller will perform resynchronization by sending an ST+DT information message 630, with an attendant period of time needed for transmitting the ST+DT information message 630. To capture the proper sample of sensor data on the next sensor Output Data Period, the host controller must poll the sensor before the fastest sensor has updated (See fast sensor timestamp 618 indicating its data is ready just before time point 632), and is shown at mark 634 as the maximum time for a sensor read window (i.e., Max Read Window 636) before the fast sensor has its data ready. The time for the Max Read Window will need to be non-negative to ensure that the window of time is extant. To guarantee that the Max Read Window timing is a non-negative value for a given Host Jitter Max 628 and a given requirement on the fast and slow sensor time, the rate of sending the ST+DT information message 630 is set low enough that the Max Read Window is non-negative. Accordingly, the determination of the Max Read Window 636 includes actively setting or adjusting the ST+DT information message 630. Furthermore, it will be appreciated that the methodology of FIG. 6 allows for computation of determination of the number of ODR periods (e.g., period 603) for which sensor data may be sampled during a synchronization period (i.e., a T_Ph). For example, the number of ODR periods allowing for sampling of sensor data before the fastest possible sensor sampling timing would change the data to be read at a next ODR (i.e., timestamp 618 and timing mark 632) may be determined. From this determination of the number of ODR periods (or polling timing or the number of polling cycles) during a synchronization period (T_Ph) (or resynchronization if occurring after initial synchronization) may be set or determined by the host controller.

It is further noted that range of fastest to slowest sensor timings (i.e., 606 to 608) as represented in FIG. 6 do not necessarily represent a particular number of sensors, but rather it illustrating the possible range of the possible variations of a particular sensor's timings (or alternatively this could be the range of possible timer variations of a number of sensors collectively), and the number of sensors in the physical system may be one or more where the range encompasses the fastest and slowest possible timings of the one or more sensors.

According to another aspect, the host controller may monitor the gradual drift of the sensor timers from the transmitted timestamps (e.g., 616, 618, 620, or other times not shown by FIG. 6) indicating time instants when data becomes available to the host controller. From this monitoring, the determinations of the minimum and/or maximum delay times (i.e., the range of variation between the slowest and fastest sensor timing) may be adjusted dynamically.

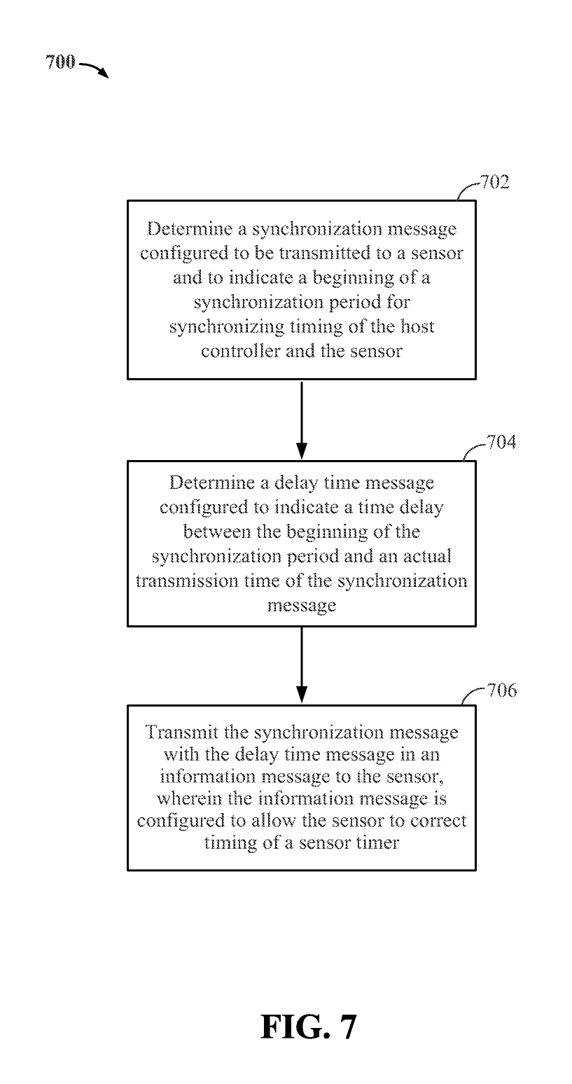

FIG. 7 illustrates a flowchart of an exemplary method 700 for transmitting sensor timing correction messages. Method 700 may be implemented with master or host controller such as with host controller 205 or processor 101, as examples. As shown at block 702, method 700 includes determining a synchronization message (e.g., an ST message), the synchronization message configured to be transmitted to a sensor (e.g., sensor 210) and to indicate a beginning of a synchronization period (e.g., the T_Ph period) for synchronizing timing of the host controller and the sensor. At block 704, the method further includes determining a delay time message (i.e., DT) configured to indicate a time delay between the beginning of the synchronization period and an actual transmission time of the synchronization message. It is noted that the process of block 704 may be effected by a host controller measuring the time from the start of the synchronization period to the actual transmission of the synchronization message.

Method 700 further includes transmitting the synchronization message along with or paired with the delay time message in an information message to the sensor, wherein the information message is configured to allow the sensor to correct timing of a sensor timer as shown in block 706. In an aspect, the DT message communicates the delay time to the sensor, that in turn allows the sensor to correct its internal timer (e.g., timer 215) accounting for this delay, thus accurately maintaining synchronization with the host controller.

As indicated before, the synchronization signal or message (e.g., a HW event and a Sync Tick (ST)) is used to indicate a beginning of a new synchronization or Time Phase period (e.g., T_Ph) and may be configured as a START condition with a command and data, or may simply be a rising edge or a falling edge of a START condition of an I²C or I3C bus message. In another example, the signal may be a message on an SPI bus. Additionally, one or more polling messages or commands (e.g., 505 or 506) may be transmitted to the sensor after the information message including ST+DT during a particular synchronization period (T_Ph), as may be seen in the example of FIG. 5. Additionally, these polling messages may be sent at a particular rate or cycle (ODR), which may also be set by the host controller.

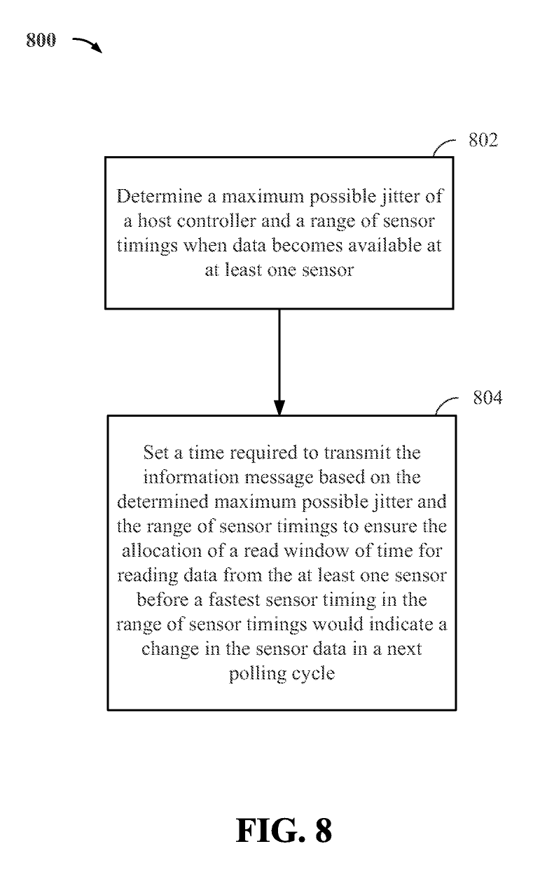

FIG. 8 illustrates a flowchart illustrating an exemplary method 800 for determining the read time window as illustrated in FIG. 6. It is first noted that method 800 may be implemented in conjunction with or in parallel with the methodology described in connection with FIG. 7. As may be seen in FIG. 8, at block 802 a determination is made of a maximum possible jitter of a host controller and a range of sensor timings when data becomes available at at least one sensor. In an aspect, the processes of block 802 may be determined by the host controller (e.g., processor 101 or host controller 205), and may be a determination of the Host Jitter Max 628 and the range of timings from the earliest timestamp 618 and the latest timestamp 620 as may be seen in FIG. 6.

Method 800 also includes the process of block 804 including setting a time required to transmit the information message (i.e., the ST+DT message) based on the determined maximum possible jitter and the range of sensor timings to ensure the allocation of a window of time for reading data from the at least one sensor (i.e., a “read window”) before a fastest sensor timing in the range of sensor timings would indicate a change in the sensor data in a next polling cycle (i.e., the next ODR cycle). The processes in block 804 may also be implemented by a host controller, such as host controller 205 or processor 101. Furthermore, the processes of block 804 include the determination and allocation of the Max Read Window 636 shown in FIG. 6 to ensure reading of data from a sensor during a current ODR period or polling cycle before the next earliest or fastest possible sensor data in a next ODR period (See e.g., 634 in FIG. 6). In an further aspect, method 800 may include determining and setting a number of polling cycles (i.e. ODR cycles) in the synchronization period based on at least one of the determined maximum read window and the fastest sensor timing in the range of sensor timings.

FIG. 9 illustrates an exemplary host controller or master device 902 that may include processing or logic circuitry 904 coupled with a transmitter/receiver circuitry 906 for transmitting and receiving signals, commands, and data on a bus interface or circuit communicatively coupled with at least slave or sensor devices. The transmitter/receiver circuitry 906 may include a timer circuit or clock 908 used at least for determining timing in synchronization of slave or sensor device coupled to the host controller 902 via the bus interface. Although not shown, the host controller 902 may employ other clocking or timing devices for internal clocking, such as clocking for the processing circuitry 904 as an example. Further, the transmitter/receiver circuitry 906 also include a transport medium interfacing circuit 910 configured to interface the transmitter/receiver circuitry with the physical interface, which may an I²C or I3C bus, or even a wireless interface as examples. Furthermore, the transport medium may employ at least two lines such as an SDA line and SCL line in the example of a bus, but could include further lines as discussed earlier with respect to interface 217 in FIG. 2.

The host controller 902 also may include a memory or storage medium 912 coupled with at least the processing circuitry 904 and include code or instructions for causing the circuitry 904 to implement or direct the transmitter/receiver circuit 906 to implement the various methodologies disclosed herein, such as those disclosed in connection with FIGS. 3-8. In another aspect, the host controller 902 may include a dedicated synchronization circuitry or logic 914 that performs some or all of the functions of effecting sensor timer correction as disclosed in FIGS. 3-8.

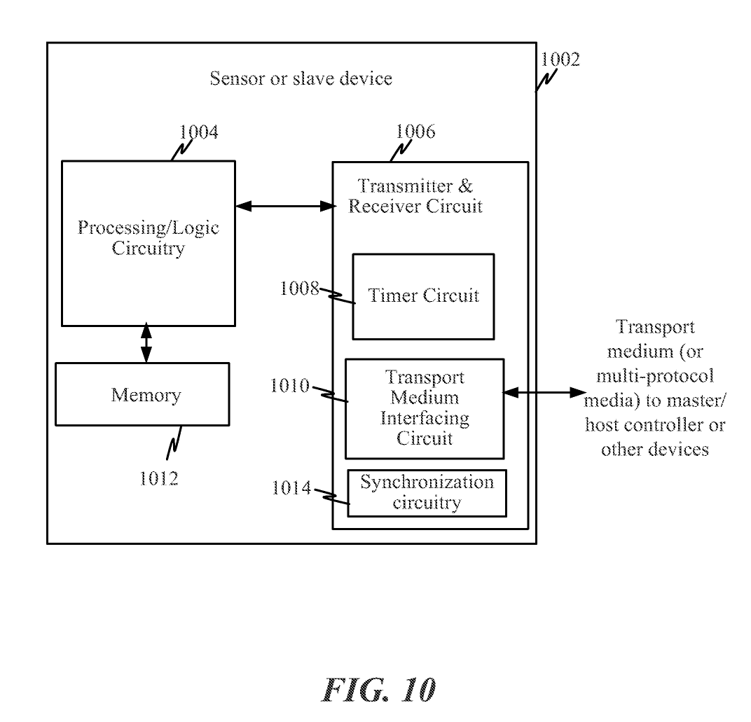

FIG. 10 illustrates an exemplary sensor or slave device 1002 that may include processing or logic circuitry 1004 coupled with a transmitter/receiver circuitry 1006 for transmitting and receiving signals and data on a bus interface or circuit communicatively coupled with at least a host controller or master device, but also other devices on the bus as well. The transmitter/receiver circuitry 1006 may include a timer circuit or clock 1008 used at least for determining timing in synchronization of the slave or sensor device 1002 under the direction of a host controller (e.g., controller 902) via the bus interface. Although not shown, the sensor 1002 may employ other clocking or timing devices for internal clocking of the sensor, such as clocking for the processing circuitry 1004 as an example. Further, the transmitter/receiver circuitry 1006 also include a transport medium interfacing circuit 1010 configured to interface the transmitter/receiver circuitry with the physical interface, which may be an I²C or I3C bus, or even a wireless interfaces just a few examples. Furthermore, the transport medium interfacing circuit 910 may employ at least two lines such as an SDA line and SCL line in the example of a bus, but could include further lines as discussed earlier with respect to interface 217 in FIG. 2.

The sensor 1002 also may include a memory or storage medium 1012 coupled with at least the processing circuitry 1004 and include code or instructions for causing the circuitry 1004 to implement or direct the transmitter/receiver circuit 1006 to implement the various methodologies disclosed herein, such as those disclosed in connection with FIGS. 3-8, particularly applying the ST+DT message for correction of the timer circuit 1008, as well as the RR command for calculating a maximum DT timing, for example. In another aspect, the sensor 1002 may include a dedicated synchronization circuitry or logic 1014 that performs some or all of the functions of effecting sensor timer correction as disclosed in FIGS. 3-8.

It should be appreciated that aspects of the invention previously described may be implemented in conjunction with the execution of instructions (e.g., applications) by processor 101 of computing device 100, host controller 205, sensor 210, host controller or master 902, and slave or sensor device 1002 as previously described. Particularly, circuitry of the device, including but not limited to processor, may operate under the control of an application, program, routine, or the execution of instructions to execute methods or processes in accordance with embodiments of the invention (e.g., the processes illustrated by FIGS. 3-8). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

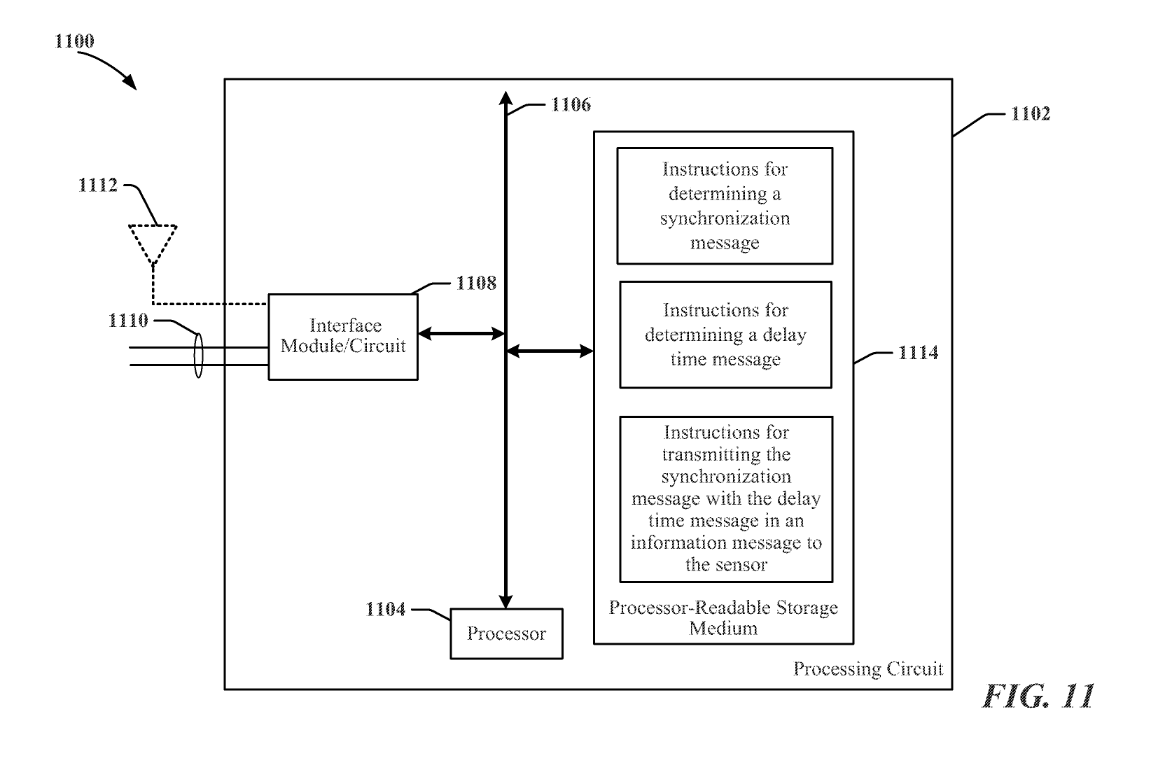

FIG. 11 is a diagram illustrating a simplified example of a hardware implementation for a host controller 1100 employing a processing circuit 1102. Examples of operations performed by the host controller 1100 include the operations described above with respect to the flow chart of FIGS. 3, 7 and 8, as well as the timelines in FIGS. 4-6. The processing circuit 1102 typically has a processor 1104 that may include one or more of a microprocessor, microcontroller, digital signal processor, a sequencer and a state machine. The processing circuit 1102 may be implemented with a bus architecture, represented generally by the bus 1106 The bus 1106 may include any number of interconnecting buses and bridges depending on the specific application of the processing circuit 1102 and the overall design constraints. The bus 1106 communicatively couples various circuits including one or more processors and/or hardware modules, represented by the processor 1104, and an interface module or circuit 1108 that is configurable to support communication over various connectors or wires 1110 operable according to various transport protocols or wireless interfaces (as shown by optional antenna 1112) and a computer-readable storage medium 1114. The bus 1106 may also link various other circuits such as timing sources, peripherals, voltage regulators, and power management circuits, which are well known in the art, and therefore, are not described in detail herein. It is also noted that the interfaces 1110 may be one or more interfaces operable according to one or multiple transport formats, as well as being communicatively coupled to one or more slave/sensor devices or to other host controllers.

The processor 1104 is responsible for general processing, including the execution of software/instructions stored on the computer-readable storage medium 1114. The software/instructions, when executed by the processor 1104, causes the processing circuit 1102 to perform the various functions described before for any particular apparatus. The computer or processor readable storage medium 1114 may also be used for storing data that is manipulated by the processor 1104 when executing software, including data decoded from symbols transmitted over the connectors or wires 1110 or antenna 1112. The processing circuit 1102 further includes at least one of the modules/circuits 1108, which may be software modules running in the processor 1104, resident/stored in the computer-readable storage medium 1114, one or more hardware modules coupled to the processor 1104, or some combination thereof. The modules/circuits 1108 may include microcontroller instructions, state machine configuration parameters, or some combination thereof.

In one configuration, the processor readable medium 1114 includes instructions for determining a synchronization message configured to be transmitted to a sensor and to indicate a beginning of a synchronization period for synchronizing timing of the host controller and the sensor. These instructions are configured to cause the processor 1104 to perform various functions including the processes illustrated in block 702 of FIG. 7, for example. The processor readable medium 1114 also includes instructions for determining a delay time message configured to indicate a time delay between the beginning of the synchronization period and an actual transmission time of the synchronization message. These instructions are configured to cause the processor 1104 to perform various functions including the processes illustrated in block 704 of FIG. 7, for example. Additionally, the processor readable medium 1114 also includes instructions for transmitting the synchronization message with the delay time message in an information message to the sensor, wherein the information message is configured to allow the sensor to correct timing of a sensor timer. These instructions are configured to cause the processor 1104 to perform various functions including the processes illustrated in block 706 of FIG. 7, for example. Of further note, the processor readable medium 1114 may include instructions (not shown) to cause the processor 1104 to perform the functions of blocks 802 and 804 in FIG. 8, and the timeline of FIG. 6.

Methods described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

Example methods, apparatuses, or articles of manufacture presented herein may be implemented, in whole or in part, for use in or with mobile communication devices. As used herein, “mobile device,” “mobile communication device,” “hand-held device,” “tablets,” etc., or the plural form of such terms may be used interchangeably and may refer to any kind of special purpose computing platform or device that may communicate through wireless transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, or the like. It should be appreciated, however, that these are merely illustrative examples relating to mobile devices that may be utilized to facilitate or support one or more processes or operations described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described memory or storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeroes). As such, in a particular implementation, such a change of state of the portion of the storage media to store a signal representative of data and/or information constitutes a transformation of storage media to a different state or thing.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing.” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for transmitting sensor timing correction messages implemented with a host controller, comprising:
determining a synchronization message, the synchronization message configured to be transmitted to a sensor and to indicate a beginning of a synchronization period for synchronizing timing of the host controller and the sensor;
determining a delay time message configured to indicate a time delay between the beginning of the synchronization period and an actual transmission time of the synchronization message; and
transmitting the synchronization message with the delay time message in an information message to the sensor, wherein the information message is configured to allow the sensor to correct timing of a sensor timer.

2. The method of claim 1, wherein the information message is configured to allow the sensor to determine an expected beginning of a next synchronization period phase time period based on the timing of the synchronization message and the delay time message for correcting timing in the sensor.

3. The method of claim 1, further comprising:
communicating a resolution ratio command to the sensor, wherein the resolution ratio command includes a division factor of the synchronization period that is usable for calculating resolution step time for the delay time message.

4. The method of claim 3, further comprising calculating at a sensor a maximum delay time for the delay time message based on the resolution step time and a predetermined number of resolution steps for a maximum delay time.

5. The method of claim 3, wherein the resolution ratio command is configured as a two bit message that communicates a plurality of integer values applied as inverse powers of two to determine the resolution steps.

6. The method of claim 1, wherein the synchronization period comprises a time phase period (T_Ph) representable in terms of a predetermined number of sampling events occurring over the time phase period.

7. The method of claim 6, wherein the interface comprises one or more of an I²C bus, an I3C bus, an SPI bus, an SMBus, a SLIMbus, a UART bus, a Sound Wire bus, or a wireless interface.

8. The method of claim 1, further comprising:
determining a maximum possible jitter of a host controller and a range of sensor timings when data becomes available at at least one sensor; and
setting a time required to transmit the information message based on the determined maximum possible jitter and the range of sensor timings to ensure the allocation of a window of time for reading data from the at least one sensor before a fastest sensor timing in the range of sensor timings would indicate a change in the sensor data in a next polling cycle.

9. The method of claim 7, further comprising determining and setting a number of polling cycles in the synchronization period based on at least one of the determined maximum window of time for reading data from the at least one sensor and the fastest sensor timing in the range of sensor timings.

10. A host controller device comprising:
a transport medium interface configured to communicatively coupled to at least one sensor device via at least one transport medium;
at least one processing circuit communicatively coupled to the transport medium interface and configured to:
determine a synchronization message, the synchronization message configured to be transmitted to a sensor and to indicate a beginning of a synchronization period for synchronizing timing of the host controller and the sensor;
determine a delay time message configured to indicate a time delay between the beginning of the synchronization period and an actual transmission time of the synchronization message; and
transmit the synchronization message with the delay time message in an information message to the sensor, wherein the information message is configured to allow the sensor to correct timing of a sensor timer.

11. The host controller device of claim 10, wherein the information message is configured to allow the sensor to determine an expected beginning of a next synchronization period phase time period based on the timing of the synchronization message and the delay time message for correcting timing in the sensor.

12. The host controller device of claim 10, wherein the at least one processing circuit is further configured to:
communicate a resolution ratio command to the sensor, wherein the resolution ratio command includes a division factor of the synchronization period that is usable for calculating resolution step time for the delay time message.

13. The host controller device of claim 12, wherein the resolution ratio command is configured as a two bit message that communicates a plurality of integer values applied as inverse powers of two to determine the resolution steps.

14. The host controller of claim 10, wherein the transport medium comprises one or more of an I²C bus, an I3C bus, an SPI bus, an SMBus, a SLIMbus, a UART, a Sound Wire bus, or a wireless interface.

15. The host controller device of claim 10, wherein the at least one processing circuit is further configured to:
determine a maximum possible jitter of a host controller and a range of sensor timings when data becomes available at at least one sensor; and
set a time required to transmit the information message based on the determined maximum possible jitter and the range of sensor timings to ensure the allocation of a window of time for reading data from the at least one sensor before a fastest sensor timing in the range of sensor timings would indicate a change in the sensor data in a next polling cycle.

16. A processor-readable storage medium having one or more instructions which, when executed by at least one processing circuit, cause the at least one processing circuit to:
determine a synchronization message, the synchronization message configured to be transmitted from a host controller to a sensor on a transport medium and to indicate a beginning of a synchronization period for synchronizing timing of the host controller and the sensor;
determine a delay time message configured to indicate a time delay between the beginning of the synchronization period and an actual transmission time of the synchronization message; and
transmit the synchronization message with the delay time message in an information message to the sensor, wherein the information message is configured to allow the sensor to correct timing of a sensor timer.

17. The processor-readable storage medium of claim 16, wherein the information message is configured to allow the sensor to determine an expected beginning of a next synchronization period phase time period based on the timing of the synchronization message and the delay time message for correcting timing in the sensor.

18. The processor-readable storage medium of claim 16, the one or more instructions further causing the at least one processing circuit to:
communicate a resolution ratio command to the sensor, wherein the resolution ratio command includes a division factor of the synchronization period that is usable for calculating resolution step time for the delay time message.

19. The processor-readable storage medium of claim 16, wherein the transport medium comprises one or more of an I²C bus, an I3C bus, an SPI bus, an SMBus, a SLIMbus, a UART bus, a SoundWire bus, or a wireless interface.

20. The processor-readable storage medium of claim 16, the one or more instructions further causing the at least one processing circuit to:
determine a maximum possible jitter of a host controller and a range of sensor timings when data becomes available at at least one sensor; and
set a time required to transmit the information message based on the determined maximum possible jitter and the range of sensor timings to ensure the allocation of a window of time for reading data from the at least one sensor before a fastest sensor timing in the range of sensor timings would indicate a change in the sensor data in a next polling cycle.
